(19) United States
(12) Patent Application Publication
(10) Pub. No.: US 2010/0183219 A1
(43) Pub. Date: Jul. 22, 2010

(54) COLOR DISTRIBUTION ANALYSIS APPARATUS FOR ANALYZING COLOR DISTRIBUTION OF IMAGE AND COLOR DISTRIBUTION ANALYSIS METHOD THEREFOR

(75) Inventor: Teruyuki FUKAYA, Fukuoka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/688,117

(22) Filed: Jan. 15, 2010

(30) Foreign Application Priority Data
Jan. 19, 2009 (JP) 2009-008591

(51) Int. Cl. G06K 9/00

(52) U.S. Cl. 382/162

(57) ABSTRACT

A color distribution analysis apparatus analyzes color distribution of image data by counting frequencies of appearance of color types shown in readout image data. The color distribution analysis apparatus includes: a primary counter increment section that increments a primary counter with a predetermined bit width provided for each color type; a counter generation section that, when a carry is generated by allowing the primary counter increment section to increment the primary counter corresponding to the color type of the image data, generates an extended counter with a predetermined bit width corresponding to the primary counter; and an extended counter increment section that increments the extended counter in accordance with generation of the carry.

### BACKGROUND

1. Technical Field

The present invention relates to a color distribution analysis apparatus for analyzing color distribution of an image and a color distribution analysis method therefor.

2. Background Art

In image reading apparatuses, color distribution of image data, which is obtained by reading a document, is frequently measured. A purpose thereof is to correct the image data, which is obtained by reading the document and the like, into higher quality image data, or to determine what the contents of the document and the like are on the basis of the image data. One of the specific methods of measuring color distribution is to count the frequency as to which color appears for each individual pixel of the image data.

However, for example, the image data representing color types may have a width of 8 bits. In this case, if the frequencies of appearance of all the colors are intended to be counted, it is required to provided the 256×256×256 (16,777,216) counters.

In such a manner, a huge number of counters are needed. Hence, for example, if the counters are allotted to only the upper 5 bits in a location in which the color types are represented by 8 bits, one counter is allotted for each color space of 8 colors. Thereby, it is possible to reduce the number of counters.

Such a technique for counting the frequencies of appearance of color types is disclosed in, for example, JP-A-4-257984.

An image output apparatus disclosed in JP-A-4-257984 is configured to divide the color space of the all colors into a plurality of color spaces. Then, the apparatus counts the frequencies of appearance of the color types within the divided color spaces. By registering the color types in a color palette table on the basis of the frequencies of appearance, it is possible to distribute appropriate representative colors over the color space of the entire colors.

Further, since the performance of tracking characteristics in a local part of the color space is improved, it is possible to obtain a display image based on limited colors in which deterioration in image quality is small. As a result, it is possible to reduce deterioration in image quality.

As mentioned above, since the image output apparatus disclosed in JP-A-4-257984 is configured to count the frequencies of appearance of the color types for each divided space, it is possible to reduce the number of counters. However, a considerable number of counters are still needed.

For example, the color types may be represented by 5 bits. In this case, it is required to provide 32×32×32 (32,768) counters, and it is necessary for each counter to adjust a bit width thereof to the extent that the color types having the highest frequencies of appearance are countable.

The principal reason thereof is that there is a bias in the frequency of appearance of the color type in the document. That is, the counter for counting the color types of which the frequencies of appearance are low does not need a wide bit width. However, in order to cope with the bias of the color types changed in accordance with the document, it is necessary to adjust the bit width of the counter to a certain bit width by which the color types having the highest frequency of appearance can be counted.

### SUMMARY

The counter for counting the color types of which frequencies are low includes an extra bit width which is not used. Therefore, it is possible to further reduce the volume of the counter.

Accordingly, it is an object of the invention to provide a color distribution analysis apparatus capable of reducing the volume required for the counter to count the frequency of appearance of colors, and a distribution analysis method thereof.

There is provided a color distribution analysis apparatus for analyzing color distribution of image data by counting frequencies of appearance of color types shown in readout image data, the color distribution analysis apparatus including: a primary counter increment section that increments a primary counter with a predetermined bit width provided for each primary color type; a counter generation section that, when a carry is generated by allowing the primary counter increment section to increment the primary counter corresponding to the primary color type of the image data, generates an extended counter with a predetermined bit width corresponding to the primary counter; and an extended counter increment section that increments the extended counter in accordance with generation of the carry.

There is provided a color distribution analysis method of analyzing color distribution of image data by counting frequencies of appearance of color types shown in readout image data, the color distribution analysis method including the steps of: incrementing a primary counter with a predetermined bit width provided for each color type; generating an extended counter with a predetermined bit width corresponding to the primary counter when a carry is generated by incrementing the primary counter corresponding to the color type of the readout image data; and incrementing the extended counter in accordance with generation of the carry.

According to the configuration and process, even when there is a bias in color distribution, it is not necessary to set a bit width of all counters to cope with the color type having the highest frequency of appearance. In addition, it is possible to further reduce the volume required for the counter to count the frequency of appearance of colors.

### BRIEF DESCRIPTION OF THE DRAWINGS

In the accompanying drawings:

FIG. 1 is a diagram illustrating a configuration of an image reading system using a color analysis apparatus according to an embodiment of the invention;

FIG. 2 is a flowchart illustrating an operation of the scanner shown in FIG. 1;

FIG. 3 is a diagram illustrating color type data;

FIG. 4 is a diagram illustrating a minor color space;

FIG. 5 is a diagram illustrating a primary counter;

FIG. 6 is a diagram illustrating an extended counter;

FIG. 7 is a diagram illustrating color type data stored in a color type data storage area; and

FIG. 8 is a diagram illustrating a minor color space as a target of the generated extended counter.

### DETAILED DESCRIPTION

According to a first aspect of the present invention, there is provided a color distribution analysis apparatus for analyzing color distribution of image data by counting frequencies of appearance of color types shown in readout image data, the color distribution analysis apparatus including: a primary counter increment section that increments a primary counter with a predetermined bit width provided for each primary color type; a counter generation section that, when a carry is generated by allowing the primary counter increment section to increment the primary counter corresponding to the primary color type of the image data, generates an extended counter with a predetermined bit width corresponding to the primary counter; and an extended counter increment section that increments the extended counter in accordance with generation of the carry.

According to the configuration, when the primary counter, which is incremented by the primary counter increment section in accordance with the color type of the image data, is carried, the extended counter generation section generates the extended counter, and the extended counter increment section increments extended counter. Therefore, the bit width of the primary counter may be small.

Accordingly, even when there is a bias in color distribution, it is not necessary to provide the bit width of the all counters to cope with the color type having the highest frequency of appearance.

A second aspect of the present invention provides the color distribution analysis apparatus, further including: a color data processor that outputs primary color type data, which is obtained by extracting predetermined upper bits from each of the image data, as image data for analyzing the color distribution, wherein the primary counter increment section increments the primary counter provided to correspond to each of the primary color type data.

According to the configuration, the color type data, which is obtained by allowing the color data processor to extract the predetermined upper bits from the image data, is output as image data for analyzing the color distribution. Therefore, only the number of the primary counters based on the predetermined upper bits may be provided.

Accordingly, it is possible to further reduce the volume required for the counters.

A third aspect of the present invention provides the color distribution analysis apparatus, wherein when generating the extended counter, the counter generation section generates a tag in association with the extended counter, wherein readout image data converted to extended color type data is stored in the tag in order to represent an extended color type of the generated extended counter, and wherein when incrementing the extended counter, the extended counter increment section searches and increments the extended counter associated with the tag in which the corresponding extended color type data is stored.

According to the configuration, the extended counter increment section is able to search the corresponding extended counter by targeting the tag thereof when generating a carry of the primary counter. Therefore, it is not necessary to allot the extended counter to the fixed address.

Accordingly, the disposition location of the extended counter is changeable. Therefore, it is possible to allocate the extended counter without waste.

A fourth aspect of the present invention provides the color distribution analysis apparatus, wherein when generating the extended counter, the counter generation section generates the extended counter corresponding to an extended color type including the primary color type represented by the primary color type data and one or more other primary color types approximate to the primary color type.

A fifth aspect of the present invention provides the color distribution analysis apparatus, wherein the extended color type including the primary color type and the one or more other color types is determined by extracting predetermined upper bits from primary color type data or readout image data.

According to the configurations, a carry of the primary counter is generated in accordance with a certain color type, thereby generating the extended counter. That is, it can be said that the frequency of appearance is high even for other color types approximate to the color type. Therefore, by previously generating the extended counters corresponding to the other color types approximate to the color type represented by the color type data, it is possible to reduce efforts to generate the extended counters again when the primary counter of other color type generates a carry.

A sixth aspect of the present invention provides the color distribution analysis apparatus, wherein every time the carry is generated by the increment of the extended counter increment section, the counter generation section generates an additional extended counter with a predetermined width and sets information representing the number of additional times thereof, and wherein the extended counter increment section increments the extended counter in accordance with the information representing the number of additional times.

According to the configuration, in case where the increment may be insufficient even in the added counter, the counter generation section additionally generates the additional extended counter. Therefore, it is not necessary to increase the bit width of the extended counter.

According to a seventh aspect of the present invention, there is provided a color distribution analysis method of analyzing color distribution of image data by counting frequencies of appearance of color types shown in readout image data, the color distribution analysis method including the steps of: incrementing a primary counter with a predetermined bit width provided for each color type; generating an extended counter with a predetermined bit width corresponding to the primary counter when a carry is generated by incrementing the primary counter corresponding to the color type of the readout image data; and incrementing the extended counter in accordance with generation of the carry.

According to the process, when a carry is generated by the primary counter incremented in accordance with the color types of the image data, the extended counter is generated, thereby incrementing the extended counter. Therefore, the bit width of the primary counter may be small.

Accordingly, even when there is a bias in color distribution, it is not necessary to provide the bit width of the all counters in accordance with the color type having the highest frequency of appearance. Hence, it is possible to further reduce the volume required for the counters.

### Embodiment

A color distribution analysis apparatus according to an embodiment of the invention will be described as an example of a scanner with reference to the accompanying drawings.

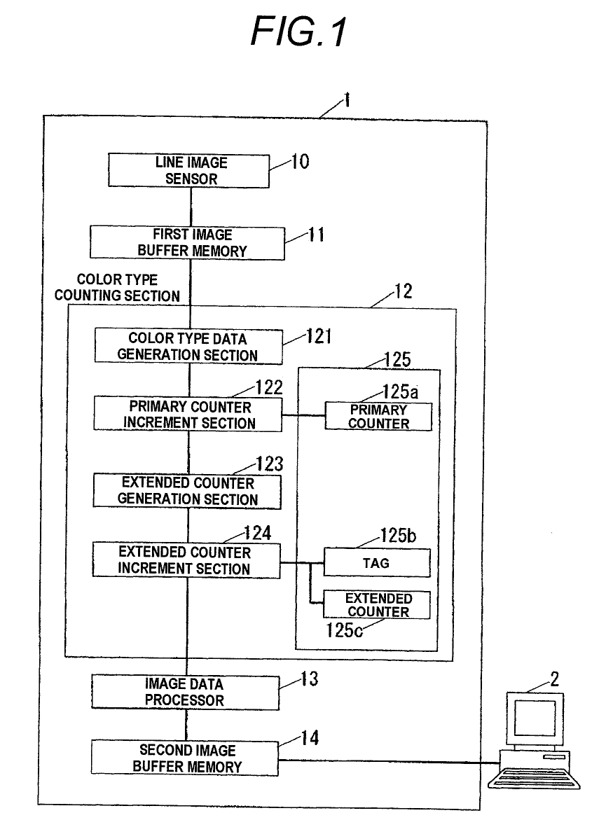

FIG. 1 is a diagram illustrating a configuration of the image reading system using the color analysis apparatus according to the embodiment of the invention. In FIG. 1, the image reading system according to the embodiment of the invention includes a scanner 1 as an image reading apparatus and a personal computer 2 (hereinafter referred to as a “PC”) as a host computer connected to the scanner 1.

The scanner 1 includes the following constituent members. A line image sensor 10 reads out a full-color image of a document in units of predetermined lines in the main scanning direction, and temporarily stores the readout image data in a first image buffer memory 11. A color type counting section 12 functions as a color distribution analysis apparatus configured to analyze color distribution of color types shown in the image data which is read out by the line image sensor 10. An image data processor 13 is configured to correct colors on the basis of the spatial distribution of the colors which is counted by the color type counting section 12. A second image buffer memory 14 is configured to temporarily store the image data, which is processed by the image data processor 13, until the image data is transmitted to the PC 2.

The line image sensor 10 is formed of generic solid-state image pickup elements such as optical-reduction type CCDs (Charge Coupled Device) or close-contact-sensor type CISs (Contact Image Sensor).

Further, in a case where the scanner 1 is a flatbed type, the document is fixed on the transparent document platen. Accordingly, the line image sensor 10 reads out the image of the document in units of predetermined lines in the main scanning direction while being moved in the sub-scanning direction. Further, in a case where the scanner 1 is a sheet-feed type, the line image sensor 10 remains stationary. Therefore, while the conveying roller moves the document in the sub-scanning direction, the line image sensor 10 reads out the image of the document in the main scanning direction in units of predetermined lines.

Note that, in the embodiment, the line image sensor 10 reads out the document in unit of one line in the main scanning direction. Alternatively, it may be possible to set the sensor to read out the image in units of a plurality of lines, for example, in units of three lines.

The first image buffer memory 11 is configured to temporarily store the image data for each individual line, which is obtained by allowing the line image sensor 10 to read out the document conveyed by the conveying roller, or the image data for each individual line, which is obtained by allowing the line image sensor 10 to read out the stationary document while moving in the sub-scanning direction, by an amount corresponding to the predetermined length in the sub-scanning direction.

The color type counting section 12 is formed of a ROM (Read Only Memory) in which a program executed by a CPU (Central Processing Unit) is stored, a RAM (Random Access Memory) which is used as a work area of the program, an ASIC (Application Specific Integrated Circuit) including a control circuit, and the like.

The color type counting section 12 has a color type data generation section 121, a primary counter increment section 122, an extended counter generation section 123, an extended counter increment section 124, and a counter section 125.

Hereinafter, the constituent elements of the color type counting section 12 shown in FIG. 1 will be described.

The color type data generation section 121 is configured to extract the predetermined upper bits of the image data and outputs those as color type data.

The primary counter increment section 122 is configured to increment a primary counter 125a of the counter section 125 on the basis of the color type data generated by the color type data generation section 121. The primary counter 125a will be described in detail later.

The extended counter generation section 123 is configured to generate a new extended counter 125c when a carry is generated by allowing the primary counter increment section 122 to increment the primary counter 125a and the extended counter 125c of the representative color data corresponding thereto is not generated yet. The extended counter 125c will also be described in detail later.

The extended counter generation section 123 is configured to increment the extended counter 125c of the corresponding color type data when a carry is generated by allowing the primary counter increment section 122 to increment the primary counter 125a.

The counter section 125 has the primary counter 125a, a tag 125b, and the extended counter 125c. The primary counter 125a can be included in the ASIC. Further, the tag 125b and the extended counter 125c can be generated in the RAM.

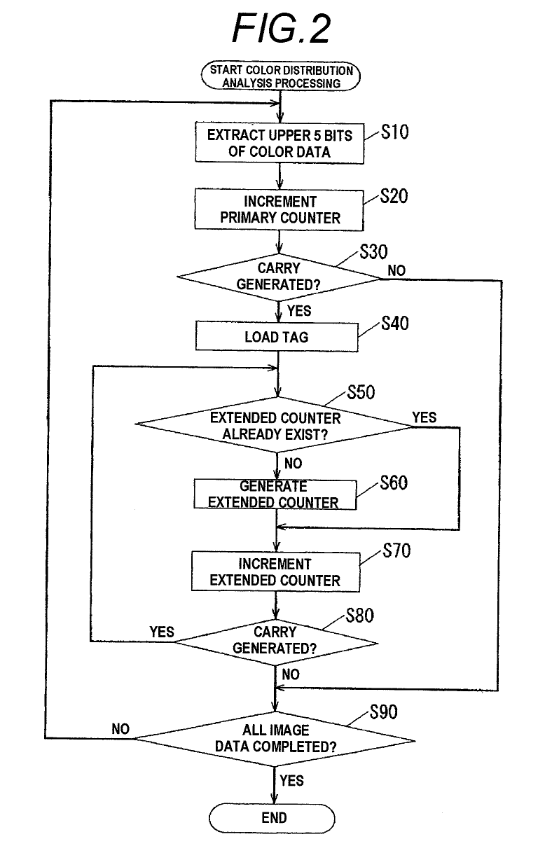

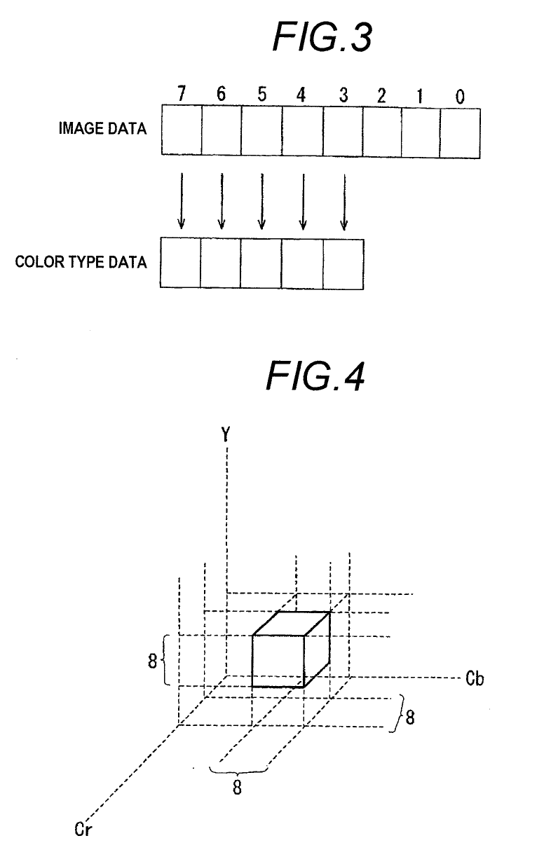

A color distribution analysis method of the scanner 1 according to the embodiment of the invention configured as described above will be described with reference to a flowchart shown in FIG. 2 and diagrams illustrated in FIGS. 3 to 8.

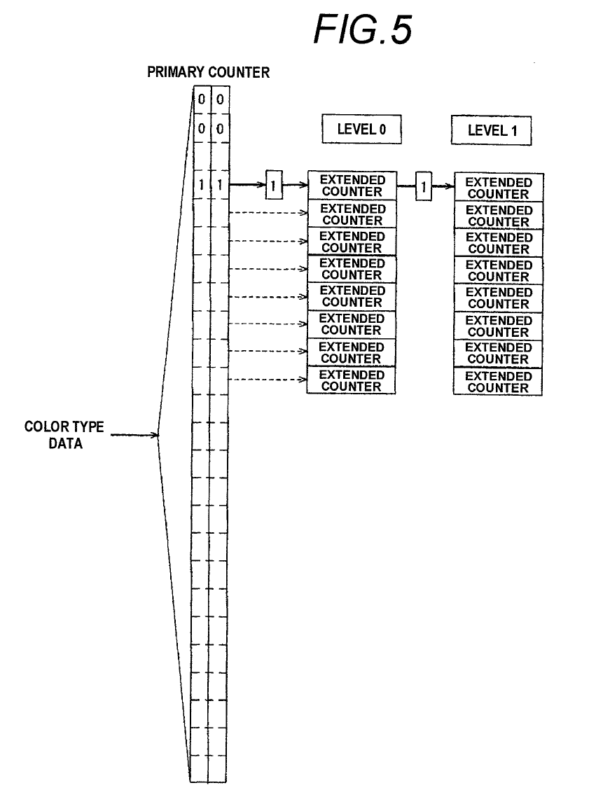

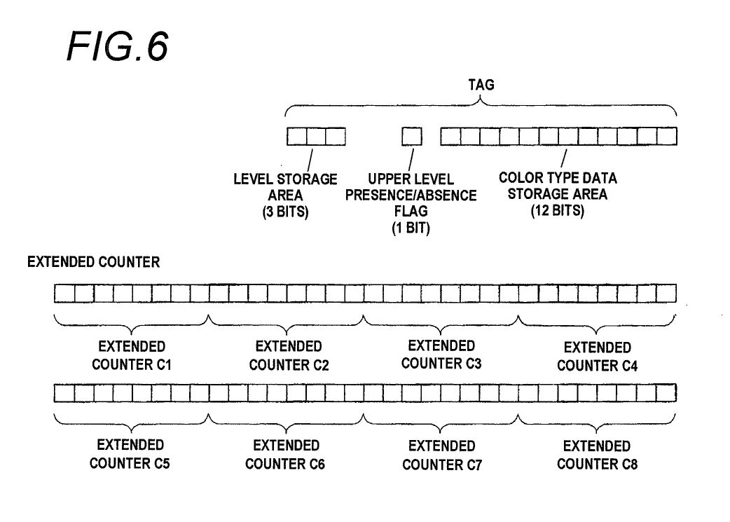

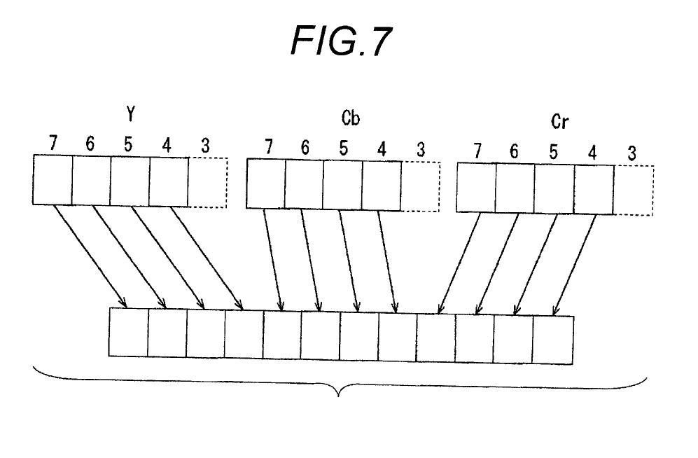

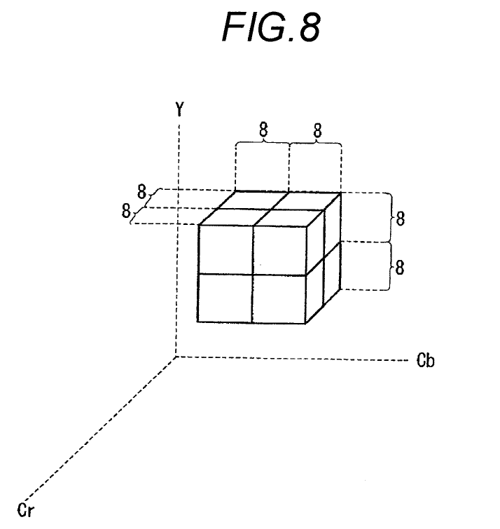

FIG. 2 is a flowchart illustrating an operation of the scanner shown in FIG. 1. FIG. 3 is a diagram illustrating color type data. FIG. 4 is a diagram illustrating a minor color space. FIG. 5 is a diagram illustrating the primary counter. FIG. 6 is a diagram illustrating the extended counter. FIG. 7 is a diagram illustrating the color type data stored in the color type data storage area. FIG. 8 is a diagram illustrating a minor color space as a target of the generated extended counter.

Before color distribution analysis processing is performed as shown in FIG. 2, as described in FIG. 1, when an operator issues an instruction to start scanning by setting a scanning condition of the scanner 1 through PC 2, the scanner 1 starts scan processing. The scanner 1 temporarily stores the image data of the document acquired by the line image sensor 10 in the first image buffer memory 11. Then, the stored image data is output from the first image buffer memory 11 to the color type counting section 12.

In FIG. 2, in the color type counting section 12, the color type data generation section 121 loads the first image data, and extracts upper 5 bits from 8 bits of each image data representing the colors (Y, Cb, and Cr) as shown in FIG. 3, thereby outputting the upper 5 bits as color type data (primary color type data) (step S10).

The color type data generation section 121 generates color type data obtained by extracting predetermined upper bits from the 8-bit image data of the document which is read first. In such a manner, the three-dimensional color space (FIG. 4) of a length of 256 (Y)×a width of 256 (Cb)×a height of 256 (Cr), in which each color is represented by 8 bits, is divided into minor color spaces of a length of 8 (Y)×a width of 8 (Cb)×a height of 8 (Cr).

In the minor color space, it is assumed that the color types included in each minor color space are the same colors. With such a configuration, it is possible to analyze the color distribution by extracting the upper 5 bits from the 8-bit image data, and it is possible to reduce the number of the color types from 16,777,216 to 32,768.

Next, the primary counter increment section 122 increments the primary counter 125a corresponding to color type data (step S20).

Here, the primary counter 125a is described with reference to FIG. 5. Each primary counter 125a is a 2-bit counter, and each 2-bit counter corresponds to each color type represented by 5 bits. Accordingly, 32,768 primary counters 125a are provided for each color type data.

The primary counter increment section 122 increments the primary counter 125a corresponding to the color type data (step S20). When the primary counter 125a is incremented, the counter values are changed from “00” to “01”, from “01” to “10”, and from “10” to “11”. When the primary counter 125a is incremented from the counter value of “11”, the counter value is changed into “00”, and thus a carry is generated.

The primary counter increment section 122 determines whether or not the primary counter 125a generates a carry (step S30). If the counter value before the increment is “00”, “01”, or “10”, no carry is generated. In contrast, if the value before the increment is “11”, a carry is generated after the increment. If the primary counter 125a does not generate a carry, the flow advances to step S90 in order to check the next image data.

If the primary counter increment section 122 determines that the primary counter 125a generates a carry, the 2-bit primary counter 125a is not able to count all the values. Therefore, the count is transferred so as to be performed by the extended counter 125c.

In the count performed by the extended counter 125c, first the extended counter generation section 123 loads the tag 125b (step S40). Here, the tag 125b and the extended counter 125c are described with reference to FIG. 6.

In FIG. 6, the tag 125b includes a 12-bit color type data storage area, a 1-bit upper level presence/absence flag, and a 3-bit level storage area. The extended counter 125c includes eight 8-bit extended counters C1 to C8.

The color type data storage area of the tag 125b stores the color type data (extended color type data) representing the color types which are counted by the extended counters C1 to C8. As shown in FIG. 7, in order to reduce the memory area necessary for the tag, the upper 4 bits are extracted from the color type data constituted by 5 bits or the 8 bits image data, those extracted bits of three dimensions (Y, Cb, Cr) are connected to each other, and thus the total-12-bit color type data is formed as the tag 125b. In this case, the color type data includes the color types belonging to the eight minor color spaces as shown in FIG. 8.

That is, when the color type included in the eight minor color spaces appears and a carry is generated in the primary counter 125a, one of the eight extended counters C1 to C8 of the extended counter 125c is incremented.

In such a manner, when there is a bias in colors, it is easily expected that the colors around the extended color are also highly likely to be extended. For this reason, there is merit in management using the tag in which the eight color parts are collected.

The upper level presence/absence flag of the tag 125b is a flag representing whether the upper extended counter (the additional extended counter) is added to the primary counter 125a.

The level storage area represents which stage of the extended counter in the area in which a level of the upper extended counter is stored.

As shown in FIG. 5, when the primary counter 125a becomes “11”, and a carry is generated by the increment, one of the eight extended counters C1 to C8 of the extended counter 125c (for example, the extended counter C1 shown in FIG. 6) is added as an extended counter of which the level is 0, thereby validating the upper level presence/absence flag shown in FIG. 6. At this time, “000” is stored in the level storage area of FIG. 6.

In FIG. 5, the extended counter of which the level is 0 also becomes “11111111” and thereafter is incremented and carried. In this case, the superior upper extended counter (for example, the extended counter C2 shown in FIG. 6) is generated and added. The extended counter becomes the level 1, the upper level presence/absence flag of the extended counter of which the level is 1 is validated. At this time, the level storage area of FIG. 6 stores “001”.

The two upper extended counters having the level 0 and the level 1 are generated, and then becomes an extended counter represented by 16 bits as a whole.

In such a manner, as shown in FIGS. 5 and 6, whenever the digits are carried, the extended counters are added sequentially from the level 0 (the level storage area “000”) to the level 7 (the level storage area “111”).

In FIG. 2, the extended counter generation section 123 loads the tag 125b, and determines whether or not there is the corresponding extended counter 125c on the basis of the color type data stored in the color type data storage area of the tag 125b (step S50).

For example, when Y corresponds to “00010”, Cb corresponds to “00101”, and Cr corresponds to “00111”, the 12-bit color type data corresponds to the upper 4 bits of those, and thus becomes “000100100011”.

Accordingly, the extended counter generation section 123 determines whether or not the tag 125b of which the color type data storage area stores “000100100011” exists. If it exists, the extended counter 125c is already generated and added to the color type data “000100100011”. Therefore, the flow advances from step S50 to step S70. If there is no tag 125b, it represents that the extended counter 125c for the color type is not generated yet.

Further, if the extended counter 125c is generated already, the extended counter generation section 123 searches whether or not the superior upper extended counter is generated. In this search, the extended counter generation section 123 determines whether or not the upper level presence/absence flag is valid. If it is invalid, the upper level extended counter than the extended counter 125c is not generated yet. Hence, this means that the extended counter 125c associated with the tag 125b is the uppermost level extended counter at the current time. Accordingly, in order to increment the extended counter 125c, the flow advances to step S70.

If the upper level presence/absence flag is valid, this means that the upper level extended counter is generated already. The color type data storage area of the tag 125b is sequentially loaded again, and the corresponding color type data is searched.

Next, the extended counter generation section 123 determines whether or not the upper level presence/absence flag of the detected tag 125b is valid. As described above, if the upper level presence/absence flag is valid, this means that the extended counter 125c further extending the extended counter 125c are provided. Therefore, by repeating the flow until the upper level presence/absence flag is invalid and the tag 125b storing the value of the highest level is searched, it is possible to search the extended counter 125c to be incremented. When the extended counter 125c to be incremented can be searched, the flow advances to step S70.

If the extended counter 125c is not generated, the extended counter generation section 123 generates the extended counter and the tag 125b of the corresponding color type, and generates the seven extended counters of the other color types approximate to the color type represented by the color type data (step S60).

The extended counter 125c is generated by generating a carry of the primary counter 125a in accordance with a certain color type. That is, it can be said that the frequency of appearance is high even for other minor color spaces approximate to the certain color type. Therefore, in a way that the extended counter generation section 123 previously generates the seven extended counters corresponding to the minor color spaces approximate to the color type represented by the color type data, it is possible to reduce the efforts to generate the extended counter again when the primary counter 125a of other color type generates a carry.

In such a manner, the extended counter generation section 123 searches the corresponding tag 125b and extended counter 125c by the upper level presence/absence flag and a level stored in the level storage area and thereby it is not necessary to allot the tag 125b and the extended counter 125c to the fixed address. Therefore, the allocated position of the extended counter 125c is changeable. As a result, it is possible to allocate the extended counter 125c without waste.

When the tag 125b and the extended counter 125c are generated, the extended counter increment section 124 increments the extended counter 125c (step S70).

Then, the extended counter coefficient section 124 determines whether or not a carry is generated (step S80). In this case, if the extended counter 125c is just generated, no carry is generated yet, the flow advances to step S90.

In step S90, the extended counter generation section 123 determines whether or not the entire image data are checked. If the entire image data is not checked, the flow returns to step S10.

Next, the case where a carry is generated in the extended counter 125c incremented in step S80 is described. If a carry is generated in the incremented extended counter 125c, the flow advances to step S50. Then, as described in step S50, the extended counter generation section 123 searches the upper level extended counter 125c by using the tag 125b. If the uppermost extended counter 125c is searched, the uppermost extended counter 125c searched in step S70 is incremented. If the uppermost extended counter 125c is not searched, the extended counter 125c to be uppermost is generated in step S60.

In step S90, if it is determined that the examination for all the image data is terminated, the color distribution analysis processing is terminated.

Next, the image data processor 13 corrects the image data. For example, it is assumed that since the background of the document is changed into yellow, the background color distribution may be biased to a yellow system. In this case, the background color is corrected to be a white color. When the image data is processed to have high quality, the image data is sequentially transmitted to the second image buffer memory 14, and finally is loaded by the PC2.

As described above, in the scanner 1 according to the embodiment, when the primary counter 125a, which is incremented by the primary counter increment section 122 in accordance with the color type of the image data, is carried, the extended counter generation section 123 generates the tag 125b and the extended counter 125c. Then, the extended counter increment section 124 increments the extended counter 125c. Therefore, the bit width of the primary counter 125a may be as small as 2 bits.

Accordingly, even when there is a bias in color distribution, it is not necessary to set a bit width of the primary counter 125a in accordance with the color type having the highest frequency of appearance. Therefore, it is possible to further reduce the volume required for the counter to count the frequency of appearance of color. Further, the primary counter 125a is provided for each color type data obtained by previously extracting the upper 5 bits from the image data represented by 8 bits. Therefore, it is possible to further reduce the volume thereof.

Furthermore, in the embodiment, the bit width of the extended counter 125c is set to 8 bits, but may be a larger bit width, or may be smaller than that.

Further, when the extended counter generation section 123 generates the extended counter 125c, the upper 4 bits are extracted from the respective color type data, thereby generating the extended counters C1 to C8 for the image data included in the eight minor color spaces. However, it may be possible to employ only the Y direction, only the Cr direction, only the Cb direction, or appropriate combination thereof.

In the embodiment, the case where colors are represented by the Y.Cb.Cr is exemplified. However, the color representation may be RGB, L*a*b* (Luminescence alpha beta), or one dimension.

Further, the color type data forming the minor color space relative to the 8-bit input color is set to have 5 bits, the bit number of the color type data relative to the bit number of the input color may be appropriately changed, and the embodiment of the invention is applicable thereto.

According to the embodiment of the invention, it is possible to reduce the volume required for the counter to count the frequency of appearance of color. Therefore, the embodiment of the invention is suitable for color distribution analysis apparatuses and color distribution analysis methods for analyzing color distribution of the image used in scanners and the like.

This application is based upon and claims the benefit of priority of Japanese Patent Application No. 2009-8591 filed on Jan. 19, 2009, the contents of which are incorporated herein by reference in its entirety.

What is claimed is:

1. A color distribution analysis apparatus for analyzing color distribution of image data by counting frequencies of appearance of color types shown in readout image data, the color distribution analysis apparatus comprising:
a primary counter increment section that increments a primary counter with a predetermined bit width provided for each primary color type;
a counter generation section that, when a carry is generated by allowing the primary counter increment section to increment the primary counter corresponding to the primary color type of the image data, generates an extended counter with a predetermined bit width corresponding to the primary counter; and
an extended counter increment section that increments the extended counter in accordance with generation of the carry.

2. The color distribution analysis apparatus according to claim 1, further comprising:
a color data processor that outputs primary color type data, which is obtained by extracting predetermined upper bits from each of the image data, as image data for analyzing the color distribution,
wherein the primary counter increment section increments the primary counter provided to correspond to each of the primary color type data.

3. The color distribution analysis apparatus according to claim 1,
wherein when generating the extended counter, the counter generation section generates a tag in association with the extended counter, wherein readout image data converted to extended color type data is stored in the tag in order to represent an extended color type of the generated extended counter, and
wherein when incrementing the extended counter, the extended counter increment section searches and increments the extended counter associated with the tag in which the corresponding extended color type data is stored.

4. The color distribution analysis apparatus according to claim 3,
wherein when generating the extended counter, the counter generation section generates the extended counter corresponding to an extended color type including the primary color type represented by the primary color type data and one or more other primary color types approximate to the primary color type.

5. The color distribution analysis apparatus according to claim 4,
wherein the extended color type including the primary color type and the one or more other color types is determined by extracting predetermined upper bits from primary color type data or readout image data.

6. The color distribution analysis apparatus according to claim 1,
wherein every time the carry is generated by the increment of the extended counter increment section, the counter generation section generates an additional extended counter with a predetermined width and sets information representing the number of additional times thereof, and
wherein the extended counter increment section increments the extended counter in accordance with the information representing the number of additional times.

7. A color distribution analysis method of analyzing color distribution of image data by counting frequencies of appearance of color types shown in readout image data, the color distribution analysis method comprising the steps of:
incrementing a primary counter with a predetermined bit width provided for each color type;
generating an extended counter with a predetermined bit width corresponding to the primary counter when a carry is generated by incrementing the primary counter corresponding to the color type of the readout image data; and
incrementing the extended counter in accordance with generation of the carry.
